(19) United States
(12) Patent Application Publication
(10) Pub. No.: US 2009/0268710 A1
(43) Pub. Date: Oct. 29, 2009

(54) UPLINK SYNCHRONIZATION WITHOUT PERIODIC RANGING IN A COMMUNICATION SYSTEM

(75) Inventors: Xiaoyong Yu, Grayslake, IL (US); Michael N. Kloos, Belvidere, IL (US); Alan P. Rottinghaus, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/107,858

(22) Filed: Apr. 23, 2008

(51) Int. Cl. H04J 3/06; H04J 11/00

(52) U.S. Cl. 370/350; 375/260

(57) ABSTRACT

An apparatus and method for uplink synchronization without periodic ranging in a communication system includes a first step (700) of detecting embedded pilot signals in data traffic from mobile stations. A next step (702) includes estimating a time error by calculating a pilot signal phase difference across a tone index within the same OFDM symbol. A next step (704) includes estimating a frequency error by calculating a pilot signal phase difference across multiple OFDM symbols within a tone. A next step (706) includes determining if at least one of the estimated time and frequency errors exceed a predetermined threshold. A next step (708) includes sending synchronization information to at least one mobile station for the mobile station to synchronize (710) its transmit signals in response to at least one of the time and frequency error.

### CROSS-REFERENCE TO RELATED APPLICATION

This application is related to U.S. patent application, Ser. No. ______ by inventor Yu, filed concurrently with this application. The related application is assigned to the assignee of the present application, and is hereby incorporated herein in its entirety by this reference thereto.

### FIELD OF THE INVENTION

This invention relates to multiple wireless communication systems, in particular, to a mechanism for synchronization in a wireless communication system.

### BACKGROUND OF THE INVENTION

The IEEE 802.16 communication standard, or WiMAX, uses an Orthogonal Frequency Division Multiple Access (OFDMA) protocol. In the OFDMA system, a mobile station (MS) is assigned a frequency sub-channel and a time slot in a physical layer for its communications with a base station, node B, or access point (AP). It is important in an OFDMA system to maintain both time and frequency synchronization. If frequency synchronization is lost then orthogonality between the various sub-carriers assigned to other MSs is also lost, which results in interference between MSs. If time error is present, system performance will be degraded due to received signal constellation rotation. Therefore, it is required in WiMAX that each MS maintains time and frequency synchronization with a base station that the MS is connected.

To solve the time synchronization problem, a ranging technique is utilized during initial communication and periodically thereafter to maintain time synchronization. Ranging involves an AP calculating a time delay error from transmissions for each MS, as is known in the art. However, an artifact of the existing logical flow in the WiMAX standard is that in cases of continuous uplink (UL) traffic, no periodic ranging is ever done. In particular, the WiMAX standard incorporates a timer to trigger each periodic time synchronization. However, if a new UL allocation is sent before the timer expires, the timer is reset. Periodic ranging is scheduled only upon the timer timing out. Therefore, if enough UL traffic exists to prevent the timer from ever expiring, no periodic ranging will ever be scheduled. Thus, if a MS travels to or from the AP its time synchronization is compromised. This will use up some of its delay spread immunity designed in with the cyclic prefix. Further, it is possible for timing to change so much that the AP can no longer receive the signal, causing the MS to drop off the network and have to re-establish network entry.

In this case, the AP is required to determine the timing error of the MS without periodic ranging. Moreover, the standard calls for ranging to be used to determine frequency error. However, determining frequency error is highly problematic if not impossible for a ranging signal with only a one symbol (periodic), or two symbol (initial) duration. In addition, empirical studies indicate that there are residual synchronization errors in physical layer after a Media Access Control (MAC) layer synchronization effort. This requires AP receiver to compensate these errors for performance improvement.

One solution for this problem is to simply schedule unsolicited RNG_RSP=continue messages periodically to force periodic ranging. The AP has no way of knowing if the MS timing has drifted because periodic ranging is anonymous. Therefore, the AP will force periodic ranging, even if it is not needed most of the time, because it has no way of knowing the actual timing error of the MS. This puts a great deal of load on the ranging channel. If there is too much load, a new channel must be allocated, cutting into throughput of the system. It also cuts down on the reliability of other ranging subscribers because the CDMA ranging is not actually orthogonal and cannot handle more than about three simultaneous ranging subscribers at a time. Any more subscribers, and none will get through and they must retry. Thus any load on the ranging channel beyond some point causes an escalating loading effect.

Although pre-Fast Fourier Transform (FFT) timing and frequency error estimate methods based on training signal or Cyclic Prefix (CP) correlation are well-known for OFDM signals, these techniques can not be applied to OFDMA systems, especially to a AP receiver, where multiple users have their own timing and frequency errors that cannot be separated from each other pre-FFT, and therefore cannot be estimated.

Accordingly, what is needed is a technique to determine the timing error of the MS without using periodic ranging. It would also be beneficial to determine the frequency error of the MS without using periodic ranging. This should be accomplished without significant channel loading or increase in interference.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows an overview block diagram of a wireless communication system supporting OFDMA, in accordance with the present invention;

FIG. 2 shows a graphical representation, for different communication devices, of synchronization errors that can presently exist in a WiMAX communication system;

FIG. 3 shows a graphical representation of a first embodiment of pilot and data signals in an OFDMA communication system, in accordance with the present invention;

FIG. 4 shows a graphical representation of a second embodiment of pilot and data signals in an OFDMA communication system, in accordance with the present invention;

FIG. 5 illustrates simulation results showing an estimated timing error averaged over 1000 trials, in accordance with the present invention;

FIG. 6 illustrates simulation results showing an estimated frequency error averaged over 1000 trials, in accordance with the present invention;

FIG. 7 is a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides a framework wherein UL timing and frequency synchronization is achieved by using data traffic, and thereby avoiding periodic ranging. For different signal structures, i.e. Partial Usage of Subchannels (PUSC) or Band Adaptive Modulation and Coding (AMC), post-FFT pilot-based timing and frequency errors are estimated by calculation of pilot signal phase ramp across a time dimension (e.g. OFMD symbol index) and a frequency dimension (e.g. tone index) respectively based on embedded pilot signals. This is accomplished without a significant increase in channel loading or interference.

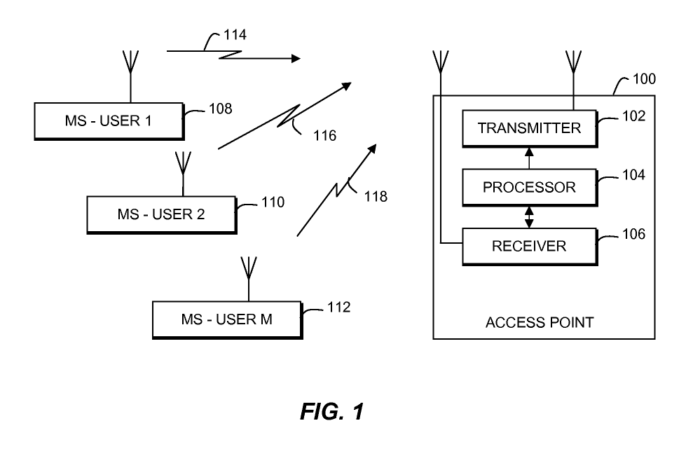

FIG. 1 is a block diagram depiction of an OFDMA wireless communication system, such as the IEEE 802.16 WiMAX system, in accordance with the present invention. At present, standards bodies such as OMA (Open Mobile Alliance), 3GPP (3rd Generation Partnership Project), 3GPP2 (3rd Generation Partnership Project 2) and IEEE (Institute of Electrical and Electronics Engineers) 802 are developing standards specifications for such wireless telecommunications systems. The communication system represents a system operable in a packet data access network that may be based on different wireless technologies. For example, the description that follows will assume that the access network is IEEE 802.XX-based, employing wireless technologies such as IEEE's 802.11, 802.16, or 802.20. Being 802.XX-based, the system is modified to implement embodiments of the present invention.

Referring to FIG. 1, there is shown a block diagram of an access point 100 adapted to support the inventive concepts of the preferred embodiments of the present invention. Those skilled in the art will recognize that FIG. 1 does not depict all of the network equipment necessary for system to operate but only those system components and logical entities particularly relevant to the description of embodiments herein. For example, an access point (AP) or base station can comprise one or more devices such as wireless area network stations (which include access nodes (ANs), AP controllers, and/or switches), base transceiver stations (BTSs), base site controllers (BSCs) (which include selection and distribution units (SDUs)), packet control functions (PCFs), packet control units (PCUs), and/or radio network controllers (RNCs). However, none of these other devices are specifically shown in FIG. 1.

Instead, AP 100 is depicted in FIG. 1 as comprising a processor 104 coupled to a transceiver, such as receiver 106 and transmitter 102. In general, components such as processors and transceivers are well-known. For example, AP processing units are known to comprise basic components such as, but not limited to, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging/signaling flow, and/or a protocol specification, those skilled in the art are aware of the many design and development techniques available to implement an AP processor that performs the given logic. Therefore, AP 100 represents a known apparatus that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the AP aspect of the present invention may be implemented in any of the devices listed above or distributed across such components. Furthermore, the various components within the AP 100 can be realised in discrete or integrated component form, with an ultimate structure therefore being merely based on general design considerations. It is within the contemplation of the invention that the operating requirements of the present invention can be implemented in software, firmware or hardware, with the function being implemented in a software processor (or a digital signal processor (DSP)) being merely a preferred option.

AP 100 uses a wireless interface for communication with one or more mobile stations, MS-USER 1 108, MS-USER 2 110 . . . MS-USER M 112. Since, for the purpose of illustration, AP 100 is IEEE 802.16-based, wireless interfaces correspond to a forward link and a reverse link, respectively, each link comprising a group of IEEE 802.16-based channels and subchannels used in the implementation of various embodiments of the present invention.

Mobile stations (MS) or remote unit platforms are known to refer to a wide variety of consumer electronic platforms such as, but not limited to, mobile nodes (MNs), access terminals (ATs), terminal equipment, gaming devices, personal computers, and personal digital assistants (PDAs). In particular, each MS 108, 110, 112 comprises a processor coupled to a transceiver, antenna, a keypad, a speaker, a microphone, and a display, as are known in the art and therefore not shown.

Mobile stations are known to comprise basic components such as, but not limited to, microprocessors, digital signal processors (DSPs), microcontrollers, memory devices, application-specific integrated circuits (ASICs), and/or logic circuitry. Such mobile stations are typically adapted to implement algorithms and/or protocols that have been expressed using high-level design languages or descriptions, expressed using computer instructions, expressed using messaging/signaling flow diagrams, and/or expressed using logic flow diagrams. Thus, given an algorithm, a logic flow, a messaging/signaling flow, a call flow, and/or a protocol specification, those skilled in the art are aware of the many design and development techniques available to implement user equipment that performs the given logic.

Each mobile station 108, 110, 112 provides respectively uplink signals 114, 116, 118 to the receiver 106 of the AP 100. Each of these uplink signals may present different time delay errors due to MS environmental changes, mobility, timing drift, etc. As these uplink signals 114, 116, 118 may all be transmitted on the same frequency sub-channel, they are not separable by the processor 104 of the AP 100. In accordance with IEEE 802.16, the uplink signals consist of a Cyclic Prefix (CP) followed by an N-sample block output from the Inverse Fast Fourier Transform (IFFT) of the MS processor.

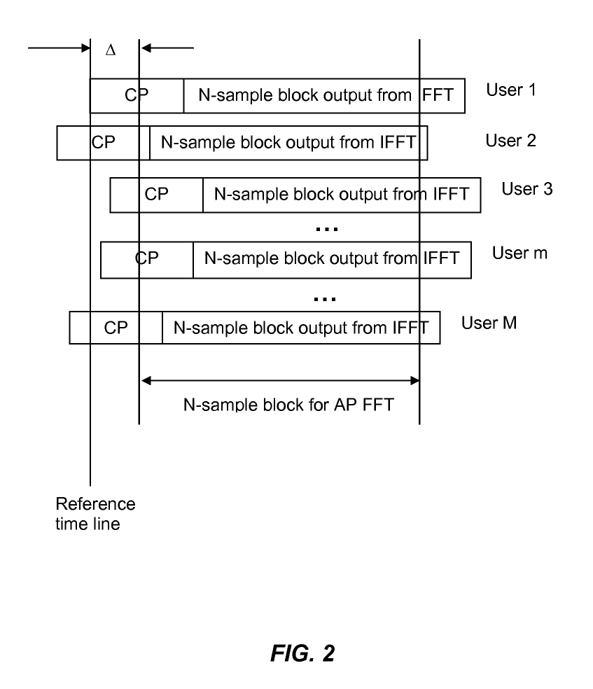

FIG. 2 illustrates the aggregate uplink timing errors for uplink signals for various mobile stations, wherein each MS's signal arrives at the AP with a different timing error. After initial ranging, and during regular data communication, it is reasonable to assume that the UL timing error is within the CP length and the frequency error is less than 2% of tone spacing (per WiMAX). The role of periodic ranging is to monitor/update timing and frequency offset due to environmental changes of each MS. Based on measured timing and frequency error, the AP could instruct each MS to adjust its transmit time and frequency accordingly. However, periodic ranging may not be available, as previously described above.

In accordance with the present invention, at the AP, CP is removed by taking N samples of the received aggregate signal offset by Δ that is programmable with a default value of half of the CP length (as in a WiMAX AP modem), where N is FFT size of the system. Let τₘ be the timing error of mobile station m. We can then write the nth baseband sample in an OFDM symbol as

$${r}_{n} = {\sum }_{m = 1}^{M} {x}_{n + Δ + {τ}_{m}} ( m ) {e}^{{jφ}_{m}}$$

where x_{n+Δ+τ}_{ₘ}(m) is time shifted baseband signal transmitted from the mobile station m, and φₘ is related phase offset due to the timing error m. The data symbol on the kth tone after an N-point FFT is given as

$$\begin{matrix}{\tilde{s}}_{k} = \frac{1}{\sqrt{N}} {\sum }_{n = 0}^{N - 1} {r}_{n} {e}^{- j2π \frac{k}{N} n} \\ = \frac{1}{N} {\sum }_{n = 0}^{N - 1} [ {\sum }_{m = 1}^{M} {e}^{{jφ}_{m}} {\sum }_{i = 0}^{N - 1} {U}_{i} ( m ) {s}_{i} ( m ) {e}^{j2π \frac{n + Δ + {τ}_{m}}{N} i} ] {e}^{- j2π \frac{k}{N} n} \\ = {e}^{{jφ}_{m}} {s}_{k} ( m ) {e}^{j2π \frac{Δ + {τ}_{m}}{N} k}\end{matrix}$$

where sₖ(m) is the transmitted data symbol of mobile station m on the kth tone, Uₖ(m)=1 when the kth tone is assigned to mobile station m, otherwise it is zero. Clearly, the timing offset Δ+τₘ will cause a phase rotation in received data symbols associated with mobile station m. For each individual tone, the phase error is a linear function of the tone index k.

Next, assuming each mobile has a frequency error Δfₘ in fraction of sampling frequency, (without loss of generality, we assume zero initial phase for simplicity), the discrete samples can be expressed as

$${r}_{n} = {\sum }_{m = 1}^{M} {x}_{n} ( m ) {e}^{j2π Δ {f}_{m} n}$$

Based on the linearity of the FFT, we consider the FFT of each mobile separately. Then the final result is the summation of FFT outputs for each mobile. One OFDM symbol consists of (N+N_{CP}) samples, where N_{CP} represents the number of samples in the CP, the kth tone of the pth OFDM after N-point FFT for mobile station m can be written as (In the following equation, the indicator m is kept for Δfₘ only to distinguish each mobile's frequency error, while m has been dropped from other variables for simplicity.)

$$\begin{matrix}{\tilde{s}}_{k} ( p ) = \frac{1}{\sqrt{N}} {\sum }_{n = 0}^{N - 1} {r}_{n + ( p - 1 ) N + {pN}_{CP}} {e}^{- j2π \frac{k}{N} n} \\ = \frac{1}{N} {\sum }_{n = 0}^{N - 1} [ {\sum }_{i = 0}^{N - 1} {s}_{i} ( p ) {e}^{j2π \frac{n}{N} i} ] {e}^{j2πΔ {f}_{m} ( n + ( p - 1 ) N + {pN}_{CP} )} {e}^{- j2π \frac{k}{N} n} \\ \approx {e}^{{jΦ}_{m} ( p )} {s}_{k} ( p ) + {e}^{{jΦ}_{m} ( p )} \frac{1}{N} {\sum }_{i = 0 , i \neq k}^{N - 1} {s}_{l} ( p ) {\sum }_{n = 0}^{N - 1} {e}^{j2π \frac{n}{N} ( i - k )} {e}^{j2πΔ {f}_{m} n}\end{matrix}$$

where Φₘ(p)=2πΔfₘ((p−1)N+pN_{CP}) is a phase due to frequency error Δfₘ for OFDM symbol p associated with mobile station m. This phase is common to all tones of mobile station m within a particular OFDM symbol. The second term of the above equation represents Inter-Carrier Interference (ICI) from other tones. It should be noted that the approximation is based on the fact that

e^{j2πΔf}^{ₘ}^{k}≈1 for very small Δfₘ

Therefore, the impact of frequency error is a common phase rotation for all tones in an OFDM symbol plus ICI from other tones. For each OFDM symbol, the phase is a linear function of time or OFDM symbol index p.

Based on analysis above, timing and frequency error estimates can be determined as: (a) timing error estimate is determined by the phase difference along the tone index within the same OFDM symbol; and (b) frequency error estimate is calculated by the phase difference across multiple OFDM symbols along the same tone index. Depending on PUSC or AMC mode, two embodiments of the present invention is described in detail below.

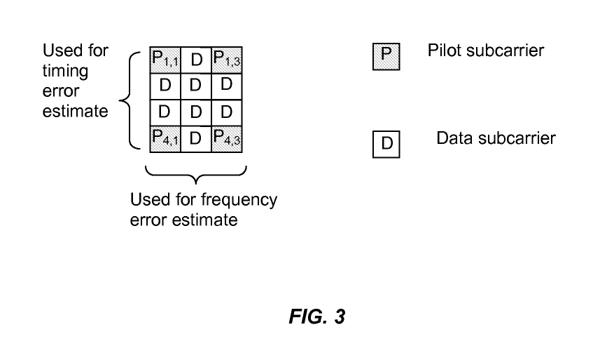

FIG. 3 represents a first embodiment of the present invention of a PUSC implementation and shows a PUSC tile structure and a pair of pilot signals used for timing and frequency error estimates. Each pilot signal in a tile is identified by a pair of indices (k, n), with k=1 or 4 and n=1 or 3, i.e. the pilot signal is on the first or fourth tone, and first or third OFDM symbol of tile t.

The timing and frequency error of mobile station m can be calculated as

$${τ}_{m} = \frac{N \times {Φ}_{m}}{6 π} - Δ and Δ {f}_{m} = \frac{{Ω}_{m}}{4 π \times {T}_{S}}$$

where T_{S} is OFDM symbol interval including CP,

$${Φ}_{m} = angle ( \frac{1}{T} {\sum }_{t = 1}^{T} ( {P}_{4 , 1} ( t ) {P}_{1 , 1}^{*} ( t ) + {P}_{4 , 3} ( t ) {P}_{1 , 3}^{*} ( t ) ) )$$

$$and$$

$${Ω}_{m} = angle ( \frac{1}{T} {\sum }_{t = 1}^{T} ( {P}_{1 , 1}^{*} ( t ) {P}_{1 , 3} ( t ) + {P}_{1 , 3}^{*} ( t ) {P}_{4 , 3} ( t ) ) )$$

where T is number of total tiles assigned to mobile station m.

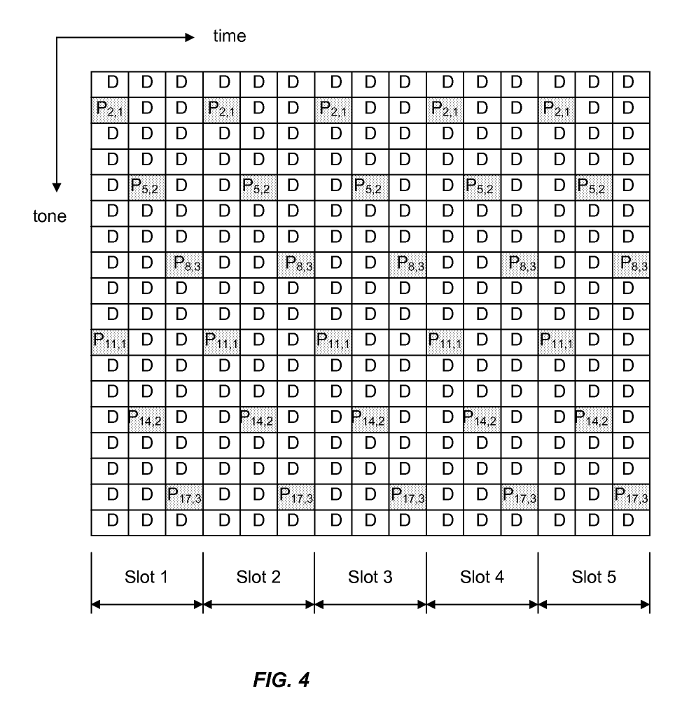

FIG. 4 represents a second embodiment of the present invention of an AMC implementation and shows a 2×3 AMC signal structure, which is one sub-channel consisting of a number (five in this example) of consecutive slots in time to form a stripe. Each slot has eighteen tones across three OFDM symbols. Similarly, the timing and frequency error of mobile station m can be determined as

$${τ}_{m} = \frac{N \times {Φ}_{m}}{18 π} - Δ and Δ {f}_{m} = \frac{{Ω}_{m}}{6 π \times {T}_{S}}$$

where T_{S} is OFDM symbol interval including CP,

$${Ω}_{m} = angle ( \frac{1}{S} {\sum }_{s = 1}^{S} ( {P}_{11 , 1} ( s ) {P}_{2 , 1}^{*} ( s ) + {P}_{14 , 2} ( t ) {P}_{5 , 2}^{*} ( s ) + {P}_{17 , 3} ( s ) {P}_{8 , 3}^{*} ( s ) ) )$$

here S is number of total slots in a sub-channel assigned to mobile station m, s is slot index, e.g., P_{14,2}(3) means the pilot in 14^{th} tone of 2^{nd} OFDM symbol in slot 3; and

$${Ω}_{m} = angle \{ \frac{1}{s ( S - 1 )} [ {\sum }_{k = 1}^{3} {\sum }_{s = 1}^{S - 1} ( \begin{matrix}{P}_{3 ( k - 1 ) + 2 , s ( s - 1 ) + k}^{*} {P}_{3 ( k - 1 ) + 2 , 3 s + k} + \\ {P}_{3 ( k - 1 ) + 11 , 3 ( s - 1 ) + k}^{*} {P}_{3 ( k - 1 ) + 11 , 3 s + k}\end{matrix} ) ] \}$$

where S is number of total slots in a sub-channel assigned to mobile station m, the subscript of pilot represents relative tone index within a slot and OFDM symbol index of all assigned slots respectively, e.g., for k=2, s=3, the pilot P_{3(k-1)+k,3s+k}=P_{5,11} that is the pilot in the 5^{th} tone of 11^{th} OFDM symbol for all assigned slots (or the 5^{th} tone of 2^{nd} OFDM in slot 4). If the mobile station has multiple sub-channels, Φₘ and Ωₘ should be averaged over all sub-channels.

Once the timing and frequency errors are calculated, they are compared to threshold values. If the timing error or frequency error exceeds a predetermined threshold, the MS is forced to adjust accordingly.

In some cases, where the pilot signals of a particular user are separated by a large number of tones within one OFDM symbol, the above estimate technique based on phase ramp will not work properly. For example, let P_{k(i),n}, i=1, 2, . . . , K be K pilots in OFDM symbol n, where k(i) implies the K pilots are separated by a number of tones. If the timing error τₘ is large or the pilot P_{k(1),n} and P_{k(2),n} are separated by a large number of tones, there is a phase ambiguity in the calculation of P_{k(1),n}P_{k(2),n}*. Fortunately, timing error is still within the CP interval during regular data transmissions (after initial ranging), that is τₘε[−N_{CP}/2 N_{CP}/2]. Consequently, τₘ can be approximated by a value tᵤ where tᵤε[−N_{CP}/2, −N_{CP}/2+1, . . . , 1, 2, . . . , N_{CP}/2−1, N_{CP}/2] that is a set of (N_{CP}+1) integers. Clearly u=1, 2, . . . , N_{CP}, N_{CP}+1, which is element index of the integer set. The algorithm is described in the following steps:
1. All K pilots are multiplied by P_{k(1),n}* to produce another set of K pilots, Q_{k(i),n}=P_{k(i),n}P_{k(1),n}*. This effectively rotates all pilots such that the first pilot Q_{k(1),n} is a real number.
2. For every value tᵤ in the set [−N_{CP}/2, −N_{CP}/2+1, . . . , 1, 2, . . . , N_{CP}/2−1, N_{CP}/2], determine K complex numbers

$${W}_{i} ( {t}_{u} ) = {Q}_{k ( i ) , n} - \vert {Q}_{k ( i ) , n} \vert {e}^{j \frac{2 π}{N} ( {t}_{u} + Δ ) ( k ( i ) - k ( 1 ) )} ,$$

where i=1, 2, 3, . . . , K.
3. Determine a detection metric for each value of tᵤ as

$$M ( {t}_{u} ) = {\sum }_{i = 1}^{K} {\vert {W}_{i} ( {t}_{u} ) \vert}^{2} ,$$

here u=1, 2, . . . , N_{CP}, N_{CP}+1.
4. Repeat steps 1 to 3 for all antennas and all OFDM symbols that carry pilots to continue accumulate the detection metric.
5. Find the minimum metric among the (N_{CP}+1) detection metrics calculated in steps 1 to 4, say

$$M ( {t}_{o} ) = {min}_{u} \{ M ( {t}_{u} ) \} ,$$

then tₒ is/an estimate of timing error τₘ for mobile station m.

In addition, it is possible that all available pilots for frequency error estimate for a particular user are not on the same tones across two OFDM symbols. Let P_{k(i),n} and P_{b(i),s}, i=1, 2, . . . , K, be K pilots in OFDM symbol n and s respectively, where k(i) and b(i) imply the K pilots in OFDM symbol n and s are not necessarily on the same tones. In this case, frequency error estimate can be achieved by a modified algorithm in the following:

$$Δ {f}_{m} = \frac{{Ω}_{m}}{2 π \times ( s - n ) \times T}$$

where T is OFDM symbol interval and

$${Ω}_{m} = angle ( \frac{1}{K} {\sum }_{t = 1}^{K} {P}_{k ( i ) , n}^{*} \times {e}^{- j \frac{2 π}{N} ( {τ}_{m} + Δ ) ( b ( i ) - k ( i ) )} \times {P}_{b ( i ) , s} ) .$$

Uplink Space Division Multiple Access (UL SDMA) mode in WiMAX is an example of the above described cases, where T=Tₛ where Tₛ is OFDM symbol interval including Cyclic Prefix. In SDMA, two users share the same tile such that each user has two pilots at diagonally opposite corners of the tile. If SDMA users are assigned one slot resource, which consists of six tiles within three OFDM symbols, then pilot signals available for the timing error estimate may be separated by a large number of tones, due to sub-channel rotation specified in WiMAX. Also, the pilot signals used for frequency error estimate are not on the same tones. In this case, the technique above can be applied.

### EXAMPLE

Simulation data show that the present invention performs very well. In fact, it is superior in terms of estimating both timing and frequency error than the prior art ranging technique. The timing is superior to ranging due to more symbols over which to determine the estimate. The frequency estimate is superior because ranging cannot give a good frequency error estimate over such a short duration signal.

To evaluate performance of proposed method for PUSC, simulations have been conducted, where three mobiles each has a timing offset of −50, 10 and 60 samples respectively and a frequency offset 2%, −2% and 1% of tone spacing respectively. In the case of a 10 MHz WiMAX system, the frequency offset is equal to 218.75 Hz, −218.75 Hz and 109.375 Hz respectively. The three mobiles were multiplexed and transmitted over five channels, i.e., AWGN, Rician, PB3, TU50 and VA60, as are known in the art.

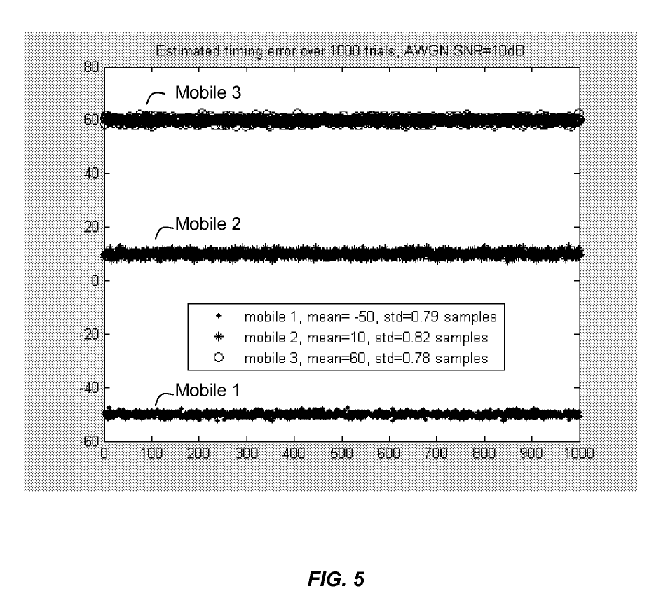

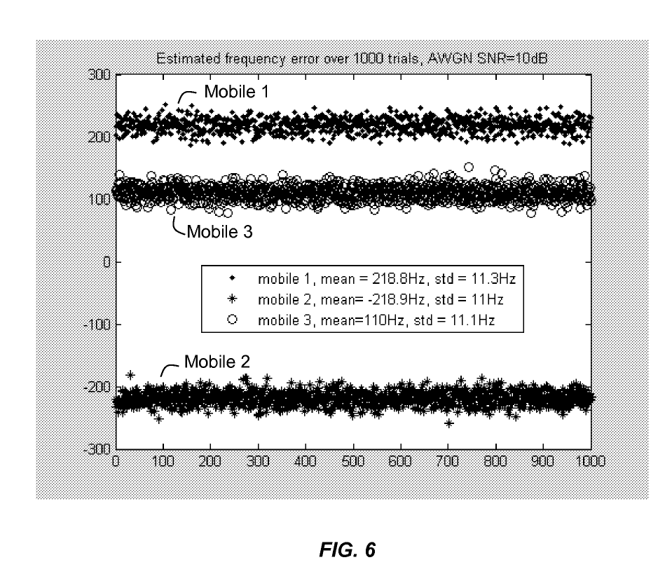

FIGS. 5 and 6 show the simulation results for the AWGN channel. Based on the results, we see the proposed method works well. It should be noted that WiMAX currently allows ±1% frequency error, but in the present invention the AP can tolerate up to 10% of CP timing error. AMC 2×3 will also work well inasmuch as AMX 2×3 has a slightly lower pilot density which could degrade performance, but this is mitigated by the pilot signal boosting of 2.5 dB in AMC and the fact that channel estimation should be better due to the contiguous nature of the subcarriers. FIG. 5 shows estimated timing error averaged over 1000 trials for the AWGN case. FIG. 6 shows the estimated frequency error averaged over 1000 trials for the AWGN case. The Rician, PB3, TU50 and VA60 simulations all show similar results but are not presented here for the sake of brevity.

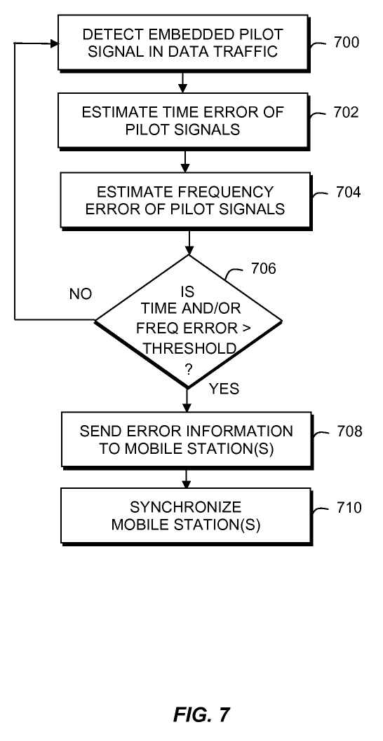

FIG. 7 shows a flowchart that illustrates a method for uplink synchronization without periodic ranging in a communication system, in accordance with the present invention. A first step 700 includes detecting embedded pilot signals in data traffic from at least one mobile station, where the Cyclic Prefix has been removed from the data traffic and the signal has been FFT transformed.

A next step 702 includes estimating a time error of the pilot signals by calculating a pilot signal phase difference across the tones in a tone index within the same OFDM symbol.

A next step 704 includes estimating a frequency error of the pilot signals by calculating a pilot signal phase difference across multiple OFDM symbols within a tone.

A next step 706 includes determining if at least one of the estimated time and frequency errors exceed a predetermined threshold, which can be determined empirically.

A next step 708 includes sending synchronization information about at least one of the time and frequency error to the at least one mobile station.

A next step 710 includes synchronizing the transmit signals of the at least one mobile station in response to at least one of the time error and frequency error.

Advantageously, the present invention provides UL synchronization based on data traffic, thereby avoiding periodic ranging. In addition, post-FFT pilot-based timing and frequency error estimate are provided for PUSC, AMC and SDMA in WiMAX.

Although the preferred embodiment of the present invention is described with reference to base stations in a WiMAX wireless communication system, it will be appreciated that the inventive concepts hereinbefore described are equally applicable to any OFDMA wireless communication system where synchronization of communication units is an issue.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for uplink synchronization in a communication system, the method comprising the step of:
detecting embedded pilot signals in mobile station data traffic;
estimating a time error of the pilot signals by calculating a pilot signal phase difference across a tone index within the same OFDM symbol;
estimating a frequency error of the pilot signals by calculating a pilot signal phase difference across multiple OFDM symbols within a tone;
sending information about at least one of the time and frequency error to the at least one mobile station; and
synchronizing the transmit signals of the at least one mobile station in response to at least one of the time error and frequency error.

2. The method of claim 1, wherein the detecting step includes removing the Cyclic Prefix from the data traffic and performing FFT.

3. The method of claim 1, wherein the communication system is a WiMAX system in a Partial Usage of Sub-channels tile structure implementation, and wherein the detecting step identifies each pilot signal in a tile by a pair of indices (k, n), with k=1 or 4 and n=1 or 3.

4. The method of claim 3, wherein the time error in the estimating a time error step is
$${τ}_{m} = \frac{N \times {Φ}_{m}}{6 π} - Δ , \\ where {Φ}_{m} = ( \frac{1}{T} {\sum }_{t = 1}^{T} ( {P}_{4 , 1} ( t ) {P}_{1 , 1}^{*} ( t ) + {P}_{4 , 3} ( t ) {P}_{1 , 3}^{*} ( t ) ) )$$
and T is number of total tiles assigned to mobile station m.

5. The method of claim 3, wherein the frequency error in the estimating a frequency error step is
$$Δ {f}_{m} = \frac{{Ω}_{m}}{4 π \times {T}_{S}} ,$$
where T_{S} is OFDM symbol interval including Cyclic Prefix,
$${Ω}_{m} = angle ( \frac{1}{T} {\sum }_{t = 1}^{T} ( {P}_{1 , 1}^{*} ( t ) {P}_{1 , 3} ( t ) + {P}_{1 , 3}^{*} ( t ) {P}_{4 , 3} ( t ) ) ) ,$$
and T is number of total tiles assigned to mobile station m.

6. The method of claim 1, wherein the communication system is a WiMAX system in a Adaptive Modulation and Coding implementation, and wherein the time error in the estimating a time error step is
$${τ}_{m} = \frac{N \times {Φ}_{m}}{18 π} - Δ , where$$
$${Ω}_{m} = angle ( \frac{1}{S} {\sum }_{s = 1}^{S} ( \begin{matrix}{P}_{11 , 1} ( s ) {P}_{2 , 1}^{*} ( s ) + \\ {P}_{14 , 2} ( t ) {P}_{5 , 2}^{*} ( s ) + {P}_{17 , 3} ( s ) {P}_{8 , 3}^{*} ( s )\end{matrix} ) ) ,$$
and S is number of total slots in a sub-channel assigned to mobile station m, s is slot index.

7. The method of claim 1, wherein the communication system is a WiMAX system in a Adaptive Modulation and Coding implementation, and wherein the frequency error in the estimating a frequency error step is
$$Δ {f}_{m} = \frac{{Ω}_{m}}{6 π \times {T}_{S}} ,$$
where T_{S} is OFDM symbol interval including Cyclic Prefix, and
$${Ω}_{m} = angle \{ \frac{1}{6 ( S - 1 )} [ {\sum }_{k = 1}^{3} {\sum }_{s = 1}^{S - 1} ( \begin{matrix}{P}_{3 ( k - 1 ) + 2 , 3 ( s - 1 ) + k}^{*} {P}_{3 ( k - 1 ) + 2 , 3 s + k} + \\ {P}_{3 ( k - 1 ) + 11 , 3 ( s - 1 ) + k}^{*} {P}_{3 ( k - 1 ) + 11 , 3 s + k}\end{matrix} ) ] \}$$
where S is number of total slots in a sub-channel assigned to mobile station m, the subscript of pilot represents relative tone index within a slot and OFDM symbol index of all assigned slots respectively.

8. The method of claim 1, wherein the communication system is a WiMAX system in a Space Division Multiple Access implementation, and wherein the time error, τₘ, in the estimating a time error step can be approximated by a value tᵤ where tᵤε[−N_{CP}/2, −N_{CP}/2+1, . . . , 1, 2, . . . , N_{CP}/2−1, N_{CP}/2] that is a set of (N_{CP}+1) integers, and u=1, 2, . . . , N_{CP}, N_{CP}+1, which is element index of the integer set, and wherein τₘ is estimated by the substeps of:
(a) multiplying all K pilots by P_{k(1),n}* to produce another set of K pilots, Q_{k(i),n}=P_{k(i),n}P_{k(1),n}* such that the first pilot Q_{k(1),n} is a real number;
(b) for every value tᵤ in the set [−N_{CP}/2, −N_{CP}/2+1, . . . , 1, 2, . . . , N_{CP}/2−1, N_{CP}/2], determining K complex numbers
$${W}_{i} ( {t}_{u} ) = {Q}_{k ( i ) , n} - \vert {Q}_{k ( i ) , n} \vert {e}^{j \frac{2 π}{N} ( {t}_{u} + Δ ) ( k ( i ) - k ( 1 ) )} ,$$
where i=1, 2, 3, . . . , K;
(c) determining a detection metric for each value of
$${t}_{u} as M ( {t}_{u} ) = {\sum }_{i = 1}^{K} {\vert {W}_{i} ( {t}_{u} ) \vert}^{2} ,$$
here u=1, 2, . . . , N_{CP}, N_{CP}+1;
(d) repeating steps (a) to (c) for all antennas and all OFDM symbols that carry pilots to continue accumulate the detection metric; and
(e) finding the minimum metric among the (N_{CP}+1) detection metrics calculated in the determining a detection metric steps (a) to (d),
$$M ( {t}_{o} ) = {min}_{u} \{ M ( {t}_{u} ) \} ,$$
where tₒ is an estimate of timing error τₘ for mobile station m.

9. The method of claim 1, wherein the communication system is a WiMAX system in a Space Division Multiple Access implementation, and wherein the frequency error in the estimating a frequency error step is
$$Δ {f}_{m} = \frac{{Ω}_{m}}{2 π \times ( s - n ) \times {T}_{s}}$$
where Tₛ is OFDM symbol interval including Cyclic Prefix, and
$${Ω}_{m} = angle ( \frac{1}{K} {\sum }_{t = 1}^{K} {P}_{k ( i ) , n}^{*} \times {e}^{- j \frac{2 π}{N} ( {τ}_{m} + Δ ) ( b ( i ) - k ( i ) )} \times {P}_{b ( i ) , s} ) ,$$
wherein P_{k(i),n} and P_{b(i),s}, i=1, 2, . . . , K, are K pilots in OFDM symbol n and s respectively, where k(i) and b(i) indicate that the K pilots in OFDM symbol n and s are not on the same tones.

10. A method for uplink synchronization in a WiMAX communication system, the method comprising the step of:
detecting embedded pilot signals in mobile station data traffic after FFT and with removed Cyclic Prefix;
estimating a time error of the pilot signals by calculating a pilot signal phase difference across a tone index within the same OFDM symbol;
estimating a frequency error of the pilot signals by calculating a pilot signal phase difference across multiple OFDM symbols within a tone;
determining if at least one of the estimated time and frequency errors exceed a predetermined threshold;
sending information about at least one of the time and frequency error to the at least one mobile station; and
synchronizing the transmit signals of the at least one mobile station in response to at least one of the time error and frequency error.

11. The method of claim 10, wherein the WiMAX communication system is in a Adaptive Modulation and Coding implementation, and wherein the time error in the estimating a time error step is
$${τ}_{m} = \frac{N \times {Φ}_{m}}{18 π} - Δ , \\ where$$
$${Φ}_{m} = angle ( \frac{1}{S} {\sum }_{s = 1}^{S} ( \begin{matrix}{P}_{11 , 1} ( s ) {P}_{2 , 1}^{*} ( s ) + \\ {P}_{14 , 2} ( s ) {P}_{5 , 2}^{*} ( s ) + {P}_{17 , 3} ( s ) {P}_{8 , 3}^{*} ( s )\end{matrix} ) ) ,$$
and S is number of total slots in a sub-channel assigned to mobile station m, s is slot index, and wherein the frequency error in the estimating a frequency error step is
$$Δ {f}_{m} = \frac{{Ω}_{m}}{6 π \times {T}_{S}} ,$$
where T_{S} is OFDM symbol interval including Cyclic Prefix, and
$${Ω}_{m} = angle \{ \frac{1}{6 ( S - 1 )} [ {\sum }_{k = 1}^{3} {\sum }_{s = 1}^{S - 1} ( \begin{matrix}{P}_{3 ( k - 1 ) + 2 , 3 ( s - 1 ) + k}^{*} {P}_{3 ( k - 1 ) + 2 , 3 s + k} + \\ {P}_{3 ( k - 1 ) + 11 , 3 ( s - 1 ) + k}^{*} {P}_{3 ( k - 1 ) + 11 , 3 s + k}\end{matrix} ) ] \}$$
where S is number of total slots in a sub-channel assigned to mobile station m, the subscript of pilot represents relative tone index within a slot and OFDM symbol index of all assigned slots respectively.

12. The method of claim 11, further comprising the step of averaging Φₘ and Ωₘ over all sub-channels if the mobile station has multiple sub-channels.

13. The method of claim 10, wherein the communication system is a WiMAX system in a Space Division Multiple Access implementation, and wherein the time error, τₘ, in the estimating a time error step can be approximated by a value tᵤ where tᵤε[−N_{CP}/2, −N_{CP}/2+1, . . . , 1, 2, . . . , N_{CP}/2−1, N_{CP}/2] that is a set of (N_{CP}+1) integers, and u=1, 2, . . . , N_{CP}, N_{CP}+1, which is element index of the integer set, and wherein τₘ is estimated by the substeps of:
(a) multiplying all K pilots by P_{k(1),n}* to produce another set of K pilots, Q_{k(i),n}=P_{k(i),n}P_{k(1),n}* such that the first pilot Q_{k(1),n} is a real number;
(b) for every value tᵤ in the set [−N_{CP}/2, −N_{CP}/2+1, . . . , 1, 2, . . . , N_{CP}/2−1, N_{CP}/2], determining K complex numbers
$${W}_{i} ( {t}_{u} ) = {Q}_{k ( i ) , n} - \vert {Q}_{k ( i ) , n} \vert {e}^{j \frac{2 π}{N} ( {t}_{u} + Δ ) ( k ( i ) - k ( 1 ) )} ,$$
where i=1, 2, 3, . . . , K;
(c) determining a detection metric for each value of tᵤ as
$$M ( {t}_{u} ) = {\sum }_{i = 1}^{K} {\vert {W}_{i} ( {t}_{u} ) \vert}^{2} ,$$
here u=1, 2, . . . , N_{CP}, N_{CP}+1;
(d) repeating steps (a) to (c) for all antennas and all OFDM symbols that carry pilots to continue accumulate the detection metric; and
(e) finding the minimum metric among the (N_{CP}+1) detection metrics calculated in the determining a detection metric steps (a) to (d),
$$M ( {t}_{o} ) = {min}_{u} \{ M ( {t}_{u} ) \} ,$$
where tₒ is an estimate of timing error τₘ for mobile station m.

14. The method of claim 10, wherein the communication system is a WiMAX system in a Space Division Multiple Access implementation, and wherein the frequency error in the estimating a frequency error step is
$$Δ {f}_{m} = \frac{{Ω}_{m}}{2 π \times ( s - n ) \times {T}_{s}}$$
where Tₛ is OFDM symbol interval including Cyclic Prefix, and
$${Ω}_{m} = angle ( \frac{1}{K} {\sum }_{t = 1}^{K} {P}_{k ( i ) , n}^{*} \times {e}^{- j \frac{2 π}{N} ( {τ}_{m} + Δ ) ( b ( i ) - k ( i ) )} \times {P}_{b ( i ) , s} ) ,$$
wherein P_{k(i),n} and P_{b(i),s}, i=1, 2, . . . , K, are K pilots in OFDM symbol n and s respectively, where k(i) and b(i) indicate that the K pilots in OFDM symbol n and s are not on the same tones.

15. A base station operable for uplink synchronization of mobile stations in a communication system, the base station comprising:
a receiver operable to receive mobile station data traffic;
a transmitter operable to send synchronization information to the mobile stations;
a processor coupled to the receiver and transmitter, the processor operable to detect embedded pilot signals in the data traffic; estimate a time error by calculating a pilot signal phase difference across a tone index within the same OFDM symbol; estimate a frequency error by calculating a pilot signal phase difference across multiple OFDM symbols within a tone; and direct each mobile station to synchronize its transmit signals in response to at least one of the time error and frequency error information from the transmitter.
